(19) United States
(12) Patent Application Publication
(10) Pub. No.: US 2022/0392422 A1
(43) Pub. Date: Dec. 8, 2022

(54) INFORMATION PROCESSING SYSTEM, INFORMATION PROCESSING METHOD, AND PROGRAM

(71) Applicant: SONY GROUP CORPORATION, Tokyo (JP)

(72) Inventors: Kouichi UCHIMURA, Tokyo (JP); Kuniaki TAKAHASHI, Tokyo (JP); Yoshiharu DEWA, Tokyo (JP); Yuki FUJIKASHI, Chiba (JP)

(73) Assignee: SONY GROUP CORPORATION, Tokyo (JP)

(21) Appl. No.: 17/642,853

(22) PCT Filed: Oct. 12, 2020
(86) PCT No.: PCT/JP2020/038442

§ 371 Date: Mar. 14, 2022

(30) Foreign Application Priority Data
Oct. 25, 2019 (JP) 2019-194286

(51) Int. Cl. G09G 5/10

(52) U.S. Cl. CPC G09G 5/10; G09G 2320/0626

(57) ABSTRACT

There is provided an information processing system, an information processing method, and a program capable of appropriately performing luminance adjustment of HDR videos. The information processing system according to an embodiment of the present technology is a system that transmits, to an output source device of an HDR video, capability information including information indicating display capability of an HDR video when a display mode is set in which luminance adjustment of an HDR video is performed by PQ hard clipping. The present technology can be applied to a TV including a display capable of displaying an HDR video.

### TECHNICAL FIELD

The present technology particularly relates to an information processing system, an information processing method, and a program capable of appropriately performing luminance adjustment of HDR videos.

### BACKGROUND ART

Content of high dynamic range (HDR) videos has been increasing not only in the movie field but also in the game field. The maximum luminance of standard dynamic range (SDR) videos is 100 nits (100 cd/m2), whereas the maximum luminance of HDR videos is, for example, 10000 nits, which exceeds the maximum luminance of SDR videos.

For example, in a case of supporting a perceptual quantization (PQ) method, a display device including an HDR display that is a display compatible with display of HDR videos adjusts luminance of HDR videos of input game content input in accordance with its own capability using a PQ curve. The PQ method is specified in SMPTE ST. 2084.

Such luminance adjustment is called tone mapping. By tone mapping, content having luminance higher than the upper limit value of an HDR display can be rendered.

Meanwhile, tone mapping is also performed in a game machine that is an output source of content. In a game machine, tone mapping is usually performed in accordance with the capability of HDR displays on the market.

### CITATION LIST

### Patent Document

Patent Document 1: Japanese Patent Application Laid-Open No. 2017-169075

### SUMMARY OF THE INVENTION

### Problems to be Solved by the Invention

Tone mapping may be performed in both a game machine and a display device. This is, for example, because the display device cannot recognize that tone mapping has already been performed, by a game machine, on an input HDR video.

As tone mapping is performed in both a game machine and a display device, tone mapping intended by the game machine is overwritten by the tone mapping in the display device.

The present technology is provided in view of such a situation, and is intended to enable appropriate luminance adjustment of HDR videos.

### Solutions to Problems

An information processing system of the first aspect of the present technology includes a communication unit that transmits, to an output source device of an HDR video, capability information including first information indicating display capability of an HDR video when a first display mode is set in which luminance adjustment of an HDR video is performed by PQ hard clipping.

An information processing system of the second aspect of the present technology includes a communication unit that acquires, from a display device including a display that is an output destination of an HDR video, capability information including first information indicating display capability of an HDR video when a first display mode is set in which luminance adjustment of an HDR video is performed by PQ hard clipping.

A program of the third aspect of the present technology is a program that causes a computer to acquire, from a display device including a display that is an output destination of an HDR video, capability information including information indicating display capability of an HDR video when a display mode is set in which luminance adjustment of an HDR video is performed by PQ hard clipping, and control luminance conversion of an HDR video to be output to the display device on a basis of the capability information.

### BRIEF DESCRIPTION OF DRAWINGS

FIG. 1 is a diagram illustrating a configuration example of a display system.

FIG. 2 is a diagram illustrating an example of a PQ curve used for tone mapping in a display device.

FIG. 3 is a diagram illustrating an example of a PQ curve used for tone mapping in a game machine.

FIG. 4 is a diagram illustrating an example of PQ hard clipping.

FIG. 5 is a diagram illustrating examples of operations of the display device during the time of PQ hard clipping.

FIG. 6 is a diagram illustrating a flow of operations performed between the game machine and the display device.

FIG. 7 is a diagram schematically illustrating pieces of data included in EDID.

FIG. 8 is a diagram illustrating a flow of operations performed between the game machine and the display device.

FIG. 9 is a diagram illustrating a flow of operations performed between the game machine and the display device.

FIG. 10 is a diagram illustrating an example of rewriting the EDID.

FIG. 11 is a diagram illustrating an example of an SCDC managed by the display device.

FIG. 12 is a diagram illustrating an example of pieces of information stored in a manufacture specific region of the SCDC.

FIG. 13 is a diagram illustrating a flow of operations performed between the game machine and the display device.

FIG. 14 is a diagram schematically illustrating pieces of data included in EDID.

FIG. 15 is a diagram schematically illustrating pieces of data included in EDID.

FIG. 16 is a block diagram illustrating a configuration example of the game machine.

FIG. 17 is a block diagram illustrating a functional configuration example of a controller in FIG. 16.

FIG. 18 is a block diagram illustrating a configuration example of the display device.

FIG. 19 is a block diagram illustrating a functional configuration example of a controller in FIG. 18.

FIG. 20 is a diagram illustrating examples of aspects of an information processing system.

FIG. 21 is a block diagram illustrating a configuration example of a computer.

### MODE FOR CARRYING OUT THE INVENTION

Hereinafter, modes for carrying out the present technology are described. The description is given in the following order.

1. PQ Hard Clipping

2. Operation to Which the Present Technology Is Applied

3. Configuration of Each Device

4. Modifications

<PQ Hard Clipping>

Configuration of Display System

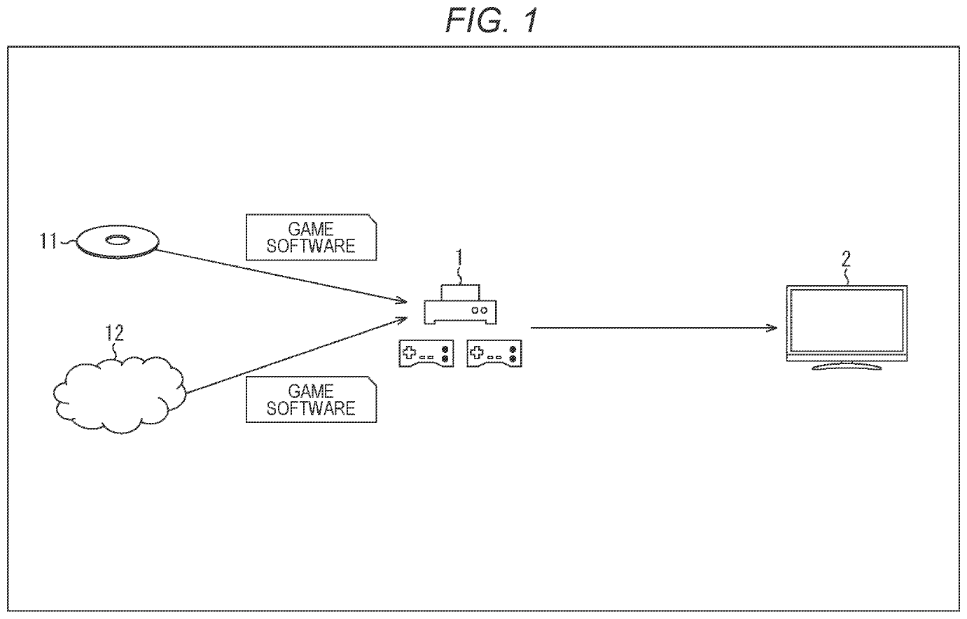

FIG. 1 is a diagram illustrating a configuration example of a display system.

The display system in FIG. 1 includes a game machine 1 and a display device 2 that are connected by a cable of a predetermined standard such as high-definition multimedia interface (HDMI) (registered trademark) 2.0a or HDMI 2.1. The game machine 1 and the display device 2 may be connected via a wireless interface.

The game machine 1 is a device that executes game software recorded on an optical disk 11 or game software provided from a predetermined server via a network 12 such as the Internet. The game software executed by the game machine 1 is a game program using an HDR video.

The game machine 1 outputs data of an HDR video obtained by executing game software to the display device 2 to cause the video of the game to be displayed. The data output from the game machine 1 includes audio data in addition to HDR video data.

The display device 2 is a display device such as a television receiver including a display including an organic electro luminescence (EL) display, a liquid crystal display (LCD), or the like. The display device 2 has a function of displaying a video input from the outside in addition to a function of receiving and displaying a program transmitted via a broadcast wave or a network as a transmission path.

The display included in the display device 2 is a display compatible with display of HDR videos having luminance exceeding 100 nits. The display device 2 receives pictures of an HDR video transmitted from the game machine 1 and causes the video of the game to be displayed.

Tone Flapping Using PQ Curve

Both the game machine 1 and the display device 2 has a function of tone mapping.

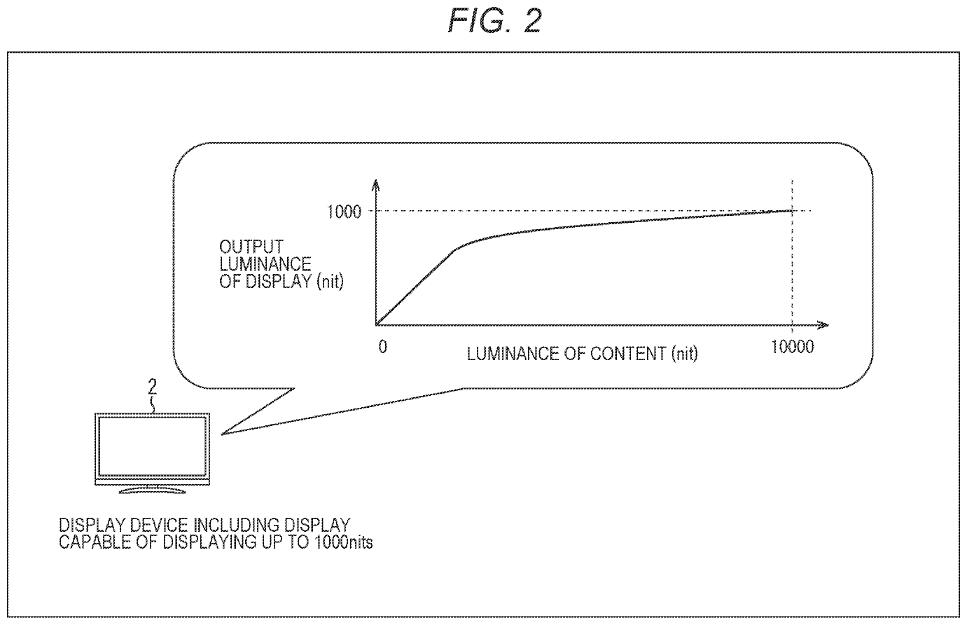

FIG. 2 is a diagram illustrating an example of a PQ curve used for tone mapping in the display device 2.

In the example of FIG. 2, the display included in the display device 2 is a display capable of displaying up to 1000 nits. In the display device 2, the PQ curve, as illustrated in a balloon, that is used for adjusting an HDR video of 0 to 10000 nits to an HDR video of 1000 nits or less is provided In the PQ curve illustrated in the balloon, the horizontal axis represents the luminance of an HDR video that can be input, and the vertical axis represents the luminance of an HDR video to be output to the display.

The PQ curve provided in the display device 2 varies depending on the capability of the display, included in the display device 2.

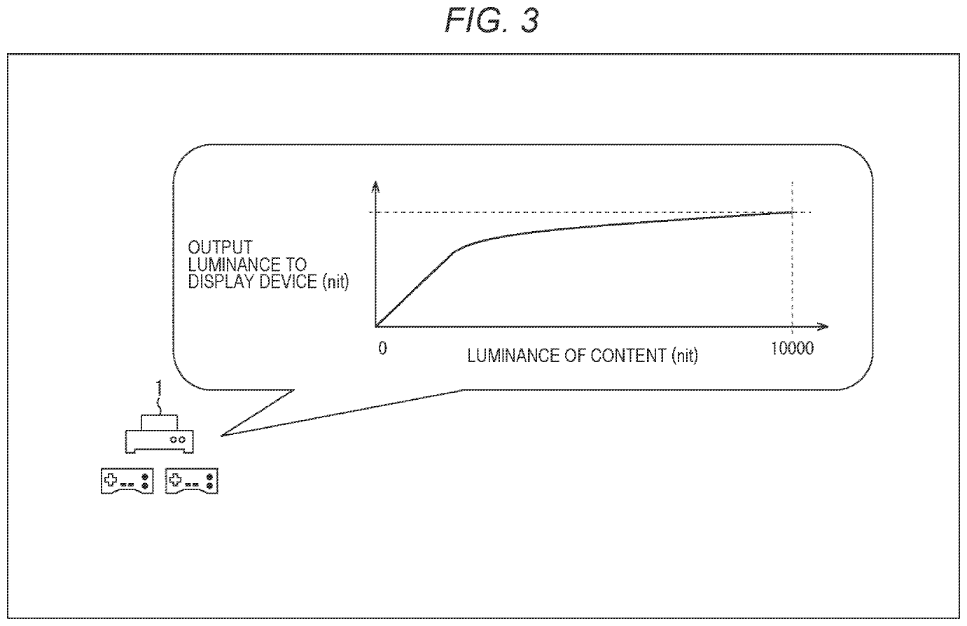

FIG. 3 is a diagram illustrating an example of a PQ curve used for tone mapping in the game machine 1.

In the game machine 1, the PQ curve, as illustrated in a balloon, that is used for adjusting an HDR video of 0 to 10000 nits to an HDR video having predetermined luminance expected as the capability of HDR displays on the market is provided.

As described above, since both the game machine 1 and the display device 2 has the function of tone mapping, in a case where tone mapping is performed in both the game machine 1 and the display device 2 during the time of outputting an HDR video, tone mapping intended by the game machine 1 is overwritten by the tone mapping by the display device 2.

As a technique for preventing tone mapping from being performed in duplicate, there is PQ hard clipping.

Regarding PQ Hard Clipping

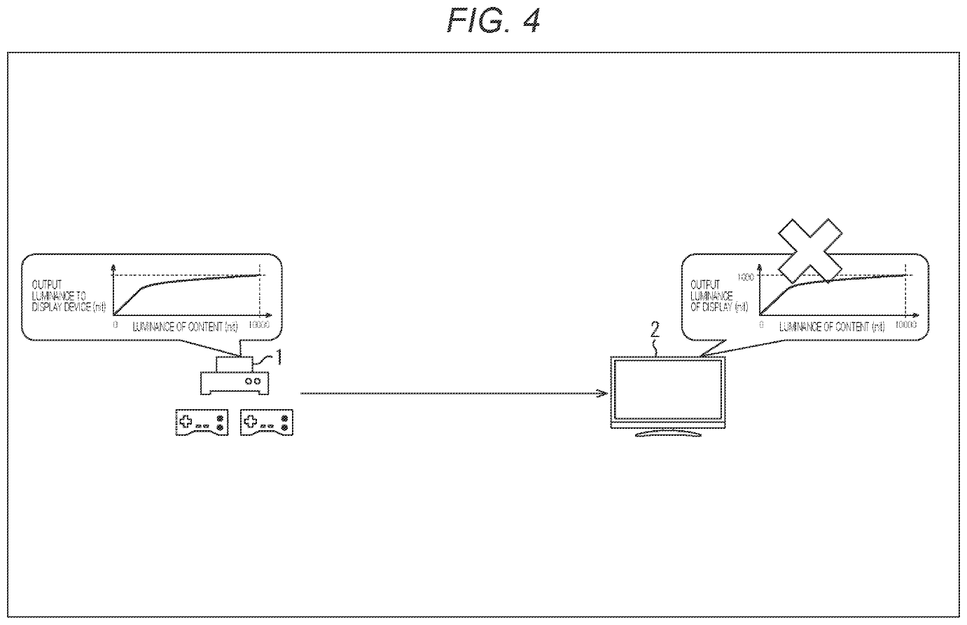

FIG. 4 is a diagram illustrating an example of PQ hard clipping.

As illustrated in FIG. 4, PQ hard clipping prevents duplicate tone mapping by causing the game machine 1 to perform tone mapping and causing the display device 2 not to perform tone mapping. Tone mapping of HDR videos is left to the game machine 1.

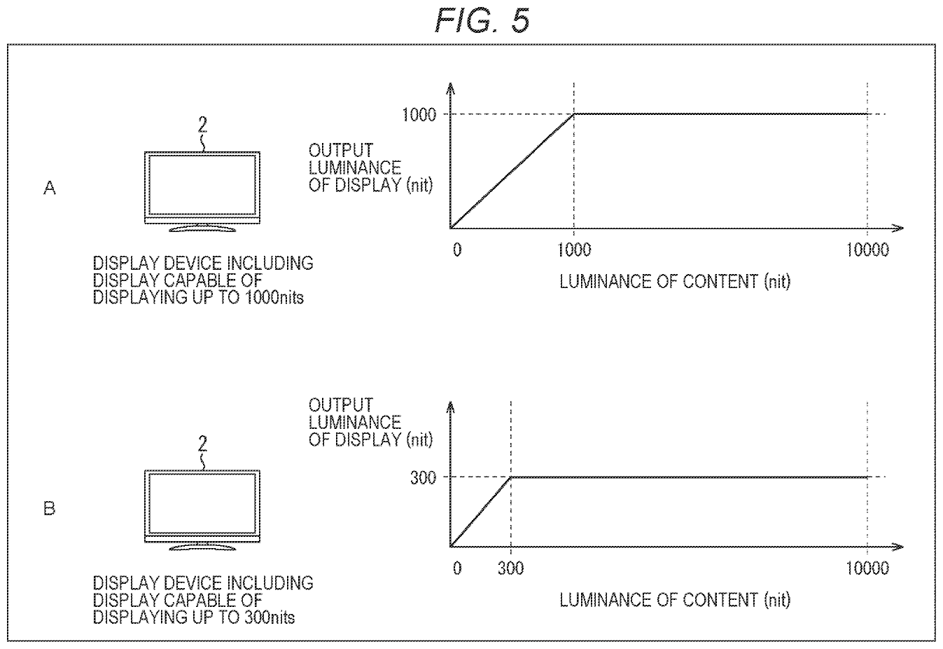

FIG. 5 is a diagram illustrating examples of operations of the display device 2 during the time of PQ hard clipping.

During the time of PQ hard clipping, the display device 2 does not perform tone mapping using a PQ curve. In the display device 2, among the luminance of an HDR video supplied from the game machine 1, luminance exceeding the maximum luminance of the display is compressed to the displayable maximum luminance.

Furthermore, in the display device 2, among the luminance of an HDR video supplied from the game machine 1, luminance lower than the minimum luminance of the display is expanded to the displayed minimum luminance during the time of PQ hard clipping. Luminance adjustment of HDR videos includes not only luminance compression but also luminance expansion.

For example, as illustrated in A of FIG. 5, in a case where the display included in the display device 2 is a display capable of displaying up to 1000 nits, among the luminance of an HDR video input from the game machine 1, luminance up to 1000 nits is output as it is. Furthermore, among the luminance of an HDR video input from game machine 1, luminance exceeding 1000 nits is compressed to 1000 nits and output.

Similarly, as illustrated in B of FIG. 5, in a case where the display included in the display device 2 is a display capable of displaying up to 300 nits, among the luminance of an HDR video input from the game machine 1, luminance up to 300 nits is output as it is. Furthermore, among the luminance of an HDR video input from game machine 1, luminance exceeding 300 nits is compressed to 300 nits and output.

In this manner, during the time of PQ hard clipping, tone mapping using a PQ curve is performed in the game machine 1, and tone mapping using a PQ curve is not performed in the display device 2. In the display device 2, luminance adjustment is performed so that among the luminance of an HDP video input from the game machine 1, luminance up to the displayable maximum luminance is output as it is, and luminance exceeding the maximum luminance is compressed to the maximum luminance and output.

In many display devices, various display modes such as cinema mode and game mode are provided. For example, processing according to a display mode is performed, in a display device, on input from a source device that is an output source of videos. PQ hard clipping can be considered as one of the display modes.

Hereinafter, a display mode in which luminance adjustment is performed by PQ hard clipping is referred to as a PQ hard clipping mode. In a case where the PQ hard clipping mode is set as a display mode of the display device 2, the display device 2 operates as described with reference to FIG. 4 and FIG. 5.

In order to operate the display device 2 in the PQ hard clipping mode, the game machine 1 needs to recognize the capability of the display of the display device 2 and perform tone mapping in accordance with the capability of the display, if the game machine 1 recognizes that the display included in the display device 2 is a display capable of displaying up to 1000 nits, the game machine 1 can perform tone mapping so that the maximum luminance is under 1000 nits, for example.

Furthermore, in order to operate the display device 2 in the PQ hard clipping mode, the game machine 1 needs to instruct the display device 2 to transition to the PQ hard clipping mode.

Operations Between Game Machine 1 and Display Device 2

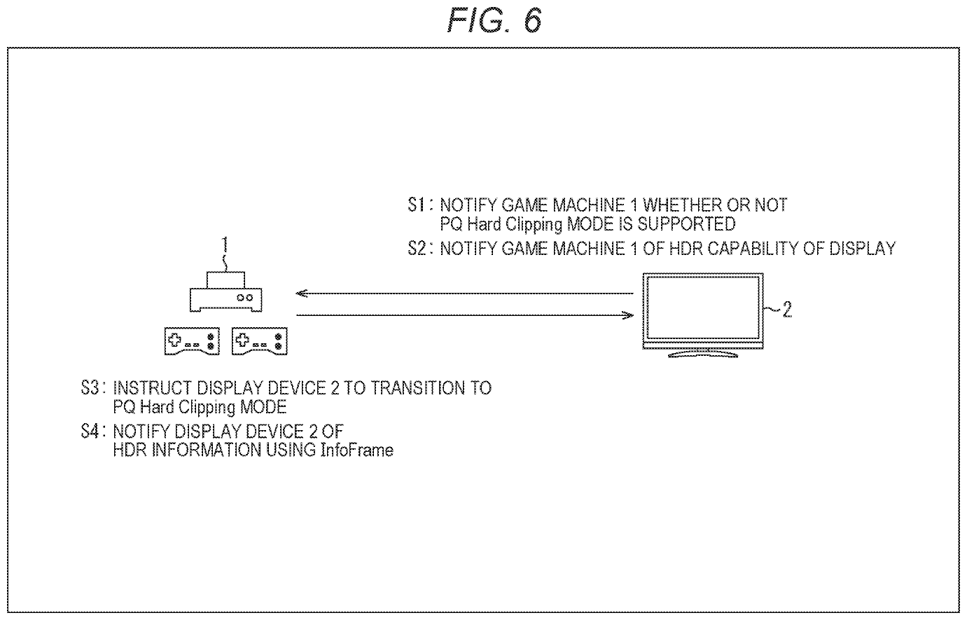

FIG. 6 is a diagram illustrating a flow of operations performed between the game machine 1 and the display device 2 in order to operate the display device 2 in the PQ hard clipping mode.

In step S1, the display device 2 notifies the game machine 1 whether or not the PQ hard clipping mode is supported.

In step S2, the display device 2 notifies the game machine 1 of the HDR capability of the display.

In a case where the display device 2 supports the PQ hard clipping mode, the game machine 1 instructs the display device 2 to transition to the PQ hard clipping mode in step S3.

In step S4, the game machine 1, using an InfoFrame, notifies the display device 2 of HDR information that is information related to an HDR video that starts to be transmitted.

When the notification in step S4 has been completed and the display mode of the display device 2 has transitioned to the PQ hard clipping mode, the game machine 1 performs tone mapping in accordance with the HDR capability of the display of the display device 2, and outputs the HDR video after the tone mapping.

Implementation Examples of Each Step

Here, a method of implementing an operation of each step is described.

The notification in step S1 is implemented using, for example, extended display identification data (EDID). EDID is information including a data block in which the capability (supported function) of a sink device is defined. EDID is defined by the video electronics standards association (VESA).

The sink device is a device including a display. In this example, the display device 2 corresponds to the sink device. The EDID managed by the display device 2 that is a sink device is capability information indicating the capability of the display device 2. Note that the game machine 1 is a source device.

For example, a flag (capability flag) indicating whether the PQ hard clipping mode is supported is defined in the EDID. The EDID including the flag indicating whether the PQ hard clipping mode is supported is transmitted from the display device 2 to the game machine 1, whereby the notification of step S1 is implemented.

The notification in step S2 is implemented by using HDR capability information written in an HDR static metadata data block that is a data block included in the EDID. The HDR capability information includes three types of information of desired content max luminance data, desired content max frame-average luminance data, and desired content min luminance data The HDR static metadata data block is defined in the CTA 861-G.

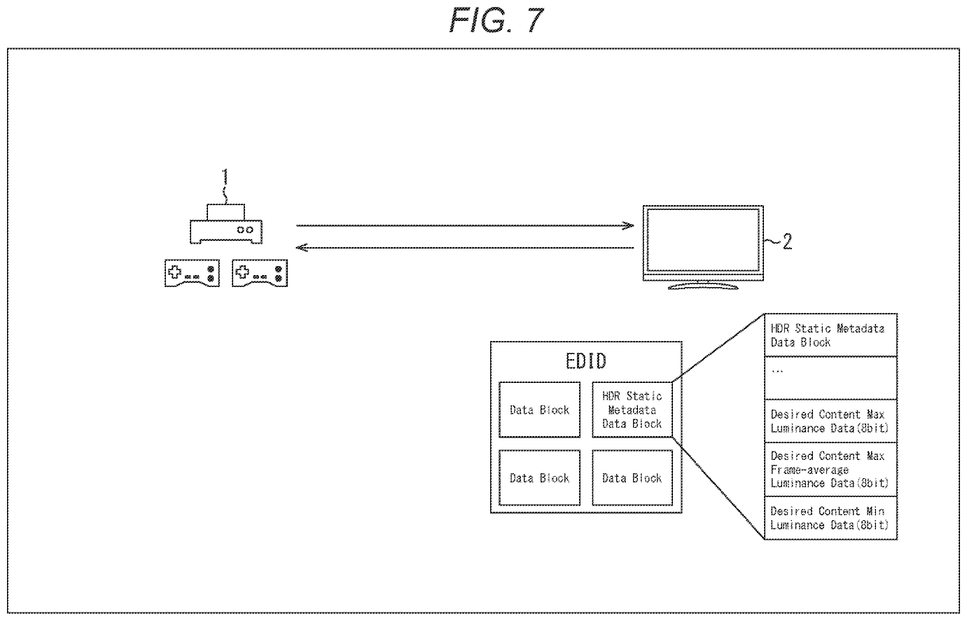

FIG. 7 is a diagram schematically illustrating pieces of data included in the EDID.

As illustrated in FIG. 7, the EDID managed by the display device 2 includes a plurality of data blocks. The HDR static metadata data block is included as one of the data blocks of the EDID.

The HDR static metadata data block includes desired content max luminance data, desired content max frame-average luminance data, and desired content min luminance data, each of which is 8-bit data.

The desired content max luminance data represents the maximum luminance of a part of the entire screen that can be received as input.

The desired content max frame-average luminance data represents the maximum value of the average luminance of the entire screen that can be received as input.

The desired content min luminance data represents the minimum luminance of a part of the entire screen that can be received as input.

The EDID including the HDR static metadata data block in which HDR capability information including such pieces of information is written is transmitted from the display device 2 to the game machine 1, whereby the notification in step S2 is implemented.

The instruction in step S3 is achieved by using an HDMI InfoFrame. For example, an InfoFrame including a flag instructing the display device 2 to transition to the PQ hard clipping mode is defined.

The HDMI InfoFrame is information transmitted from a source device to a sink device. Various types of InfoFrame such as a dynamic range and mastering InfoFrame representing the attributes of an HDR video to be output to a sink device are specified.

The InfoFrame including the flag instructing the display device 2 to transition to the PQ hard clipping mode is transmitted from the game machine 1 to the display device 2, whereby the instruction in step S3 is achieved.

Note that, in a case where the capability flag in the notification from the display device 2 in step S1 indicates that the PQ hard clipping mode is not supported, the instruction to transition to the PQ hard clipping mode is not given.

The notification in step S4 is implemented using a dynamic range and mastering InfoFrame defined in the CTA 861-G.

The dynamic range and mastering InfoFrame includes HDR information of an HDR video that starts to be transmitted. The dynamic range and mastering InfoFrame is transmitted from the game machine 1 to the display device 2, whereby the notification in step S4 is implemented.

Meanwhile, in step S2, the game machine 1 is notified of the maximum luminance, the maximum average luminance, and the minimum luminance by desired content max luminance data, desired content max frame-average luminance data, and desired content min luminance data that are written in the HDR static metadata data block included in the EDID.

However, presently, the desired content max luminance data, the desired content Max frame-average luminance data, and the desired content min luminance data are set to values on the assumption that tone mapping is to be performed in the display device 2.

Specifically, for the desired content max luminance data representing the maximum luminance and the desired content max frame-average luminance data representing the maximum average luminance, values representing luminance higher than the luminance that can be input in the PQ hard clipping mode are set.

For example, even in a case where the display included in the display device 2 is a display capable of displaying up to 1000 nits, 10000 nits is set as a value on the assumption that tone mapping is to be performed in the display device 2. As described with reference to FIG. 2, in a case where tone mapping using a PQ curve is performed in the display device 2, the luminance of an HDR video that can be input is 0 to 10000 nits.

Furthermore, for the desired content min luminance data representing the minimum luminance, a value representing luminance lower than the luminance that can be input in the PQ hard clipping mode is set.

For example, even in a case where the display included in the display device 2 is a display capable of displaying luminance of 0.1 nits or more, 0.01 nits is set as a value on the assumption that tone mapping is to be performed in the display device 2.

In a case of receiving a notification of such HDR capability information, the game machine 1 performs tone mapping expecting that the display of the display device 2 is a display compatible with luminance of 0.01 to 10000 nits, and outputs an HDR video after the tone mapping.

During operation in the PQ hard clipping mode, it is necessary to notify the game machine 1 of HDR capability information on the assumption that tone mapping is not to be performed in the display device 2, that is, the HDR capability information during the operation in the PQ hard clipping mode.

<Operation to Which the Present Technology Is Applied>

In the display system to which the present technology is applied, the game machine 1 is notified of HDR capability information indicating the display capability of the display during operation in the PQ hard clipping mode from the display device 2 during operation in the PQ hard clipping mode. The notification of HDR capability information during operation in the PQ hard clipping mode is performed by the following three methods.

(1) Change of EDID

(2) Data Block for PQ Hard Clipping Mode

(3) Extension of Existing HDR Static Metadata Data Block

Hereinafter, tone mapping performed in the display device 2 is appropriately referred to as display tone mapping. The display mode in which display tone mapping is performed is a display mode in which luminance adjustment of an HDR video is performed by a method different from the PQ hard clipping. The default display mode of the display device 2 is, for example, the display mode in which display tone mapping is performed.

(1) Change of EDID

In a case where the display mode of the display device 2 transitions to the PQ hard clipping mode, the values of HDR capability information written in the HDR static metadata data block included in the EDID are rewritten into the values for the PQ hard clipping mode in the display device 2. Using the EDID including the HDR capability information after the rewriting into the values for the PQ hard clipping mode, the game machine 1 is notified of the HDR capability of the display device 2.

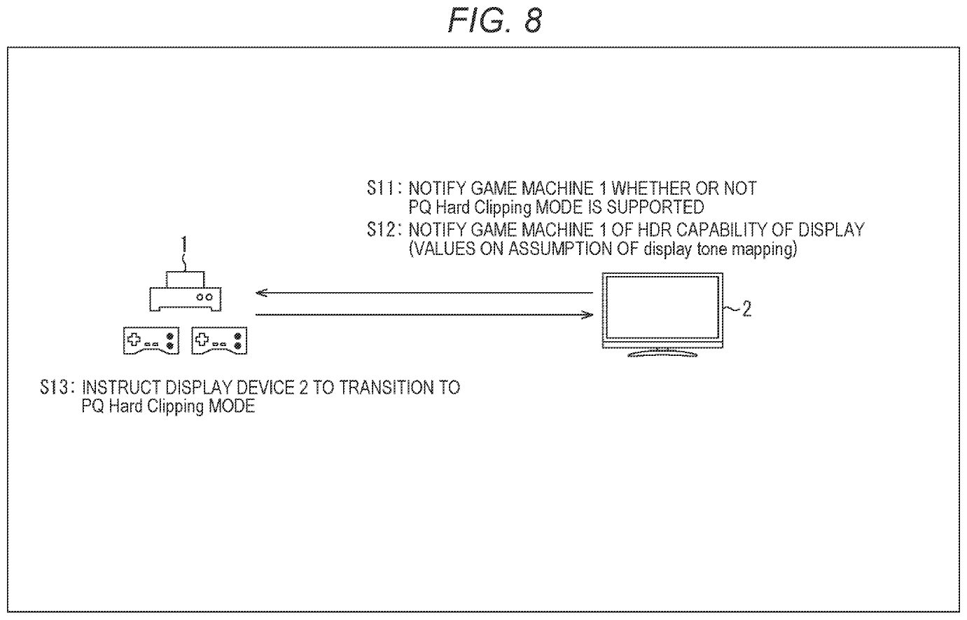

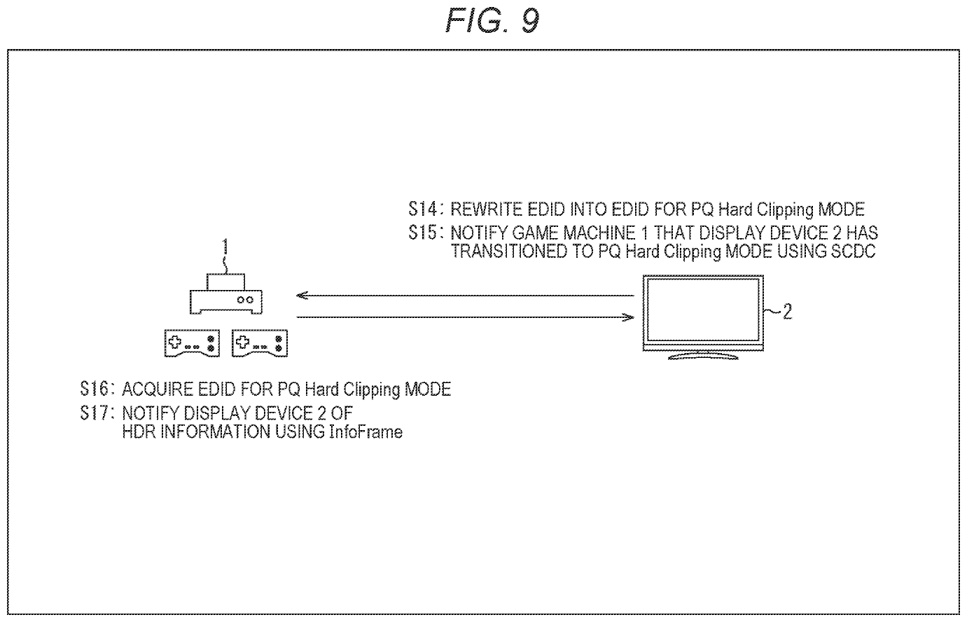

FIG. 8 and FIG. 9 are diagrams illustrating flows of operations performed between the game machine 1 and the display device 2.

The operations in steps S11, S12, and S13 illustrated in FIG. 8 are the same operations as the operations in steps S1 to S3 describes with reference to FIG. 6, respectively.

That is, in step S11, the display device 2 notifies the game machine 1 whether or not the PQ hard clipping mode, is supported. The notification as to whether or not the PQ hard clipping mode is supported is performed using a flag in the EDID.

In step S12, the display device 2 notifies the game machine 1 of the HDR capability of the display. The HDR capability in the notification here is capability on the assumption that display tone mapping is to be performed.

The game machine 1 is notified of the maximum luminance, the maximum average luminance, and the minimum luminance as the HDR capability on the assumption that display tone mapping is to be performed by the HDR capability information written in the HDR static metadata data block included in the EDID.

In a case where the display device 2 supports the PQ hard clipping mode, the game machine 1 instructs the display device 2 to transition to the PQ hard clipping mode in step S13. The instruction to transition to the PQ hard clipping mode is given using a flag in an HDMI InfoFrame.

In response to the instruction from the game machine 1, the display device 2 transitions the display mode to the PQ hard clipping mode.

After transitioning the display mode to transition to the PQ hard clipping mode, the display device 2 rewrites the EDID in step S14 or FIG. 9. The values of the HDR capability information on the assumption that display tone mapping is to be performed are rewritten into the values of HDR capability information for the PQ hard clipping mode, that is, on the assumption that display tone mapping is not to be performed.

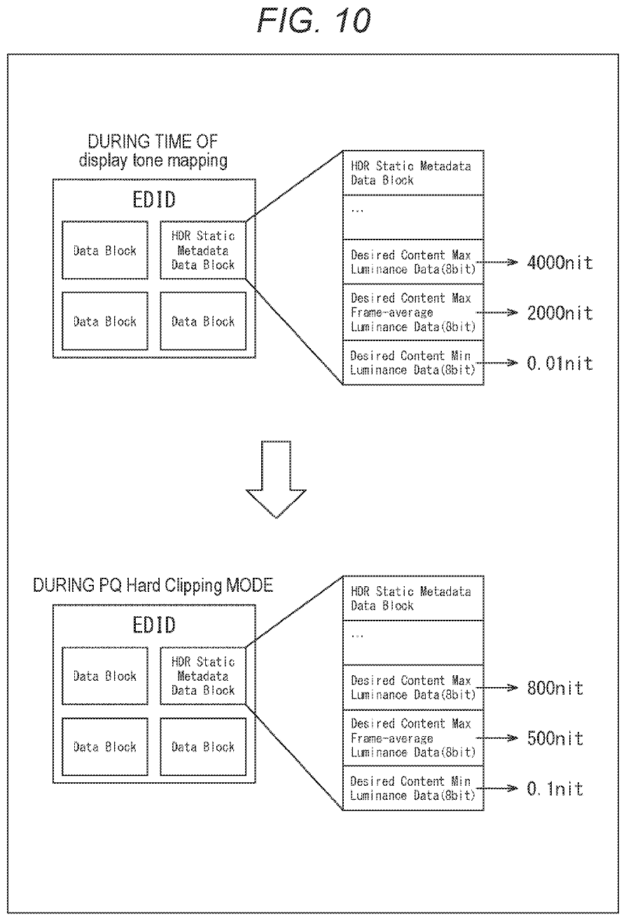

FIG. 10 is a diagram illustrating an example of rewriting the EDID.

The EDID illustrated in the upper part of FIG. 10 is EDID including the HDR static metadata data block in which the HDR capability information on the assumption that display tone mapping is to be performed is written. The values of desired content max luminance data, desired content max frame-average luminance data, and desired content min luminance data are 4000 nits, 2000 nits, and 0.01 nits, respectively.

In a case where there is the EDID in which such values are set as the values of the HDR capability information, the display device 2 rewrites the values into the values of the HDR capability information on the assumption that display tone mapping is not to be performed, as indicated by an arrow, in response to the transition to the PQ hard clipping mode.

In the example of FIG. 10, the values of the desired content max luminance data, the desired content max frame-average luminance data, and the desired content min luminance data are rewritten to 800 nits, 500 nits, and 0.1 nits, respectively.

The HDR static metadata data block, in which the HDR capability information for the PQ hard clipping mode is written, is generated by rewriting the values in this manner, and the game machine 1 is notified of the EDID including the HDR static metadata data block.

In step S15 of FIG. 9, using a status and control data channel (SCDC) specified in HDMI, the display device 2 notifies the game machine 1 that the display device 2 has transitioned to the PQ hard clipping mode.

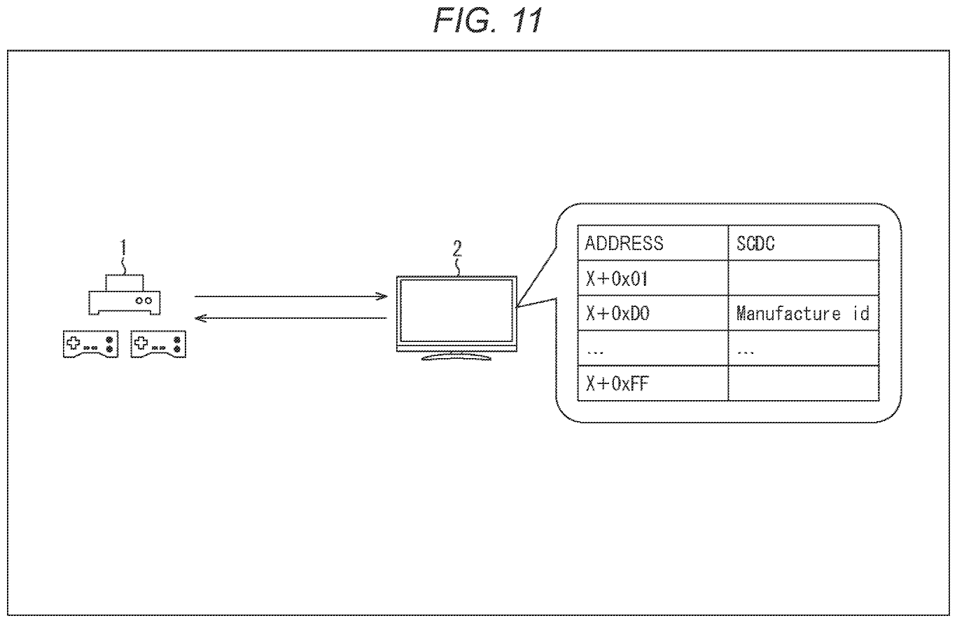

FIG. 11 is a diagram illustrating as example of the SCDC managed by the display device 2.

The SCDC is a register managed by the display device 2 as a sink device. The values of the SCDC are rewritten in response to an instruction by the game machine 1 that is a source device.

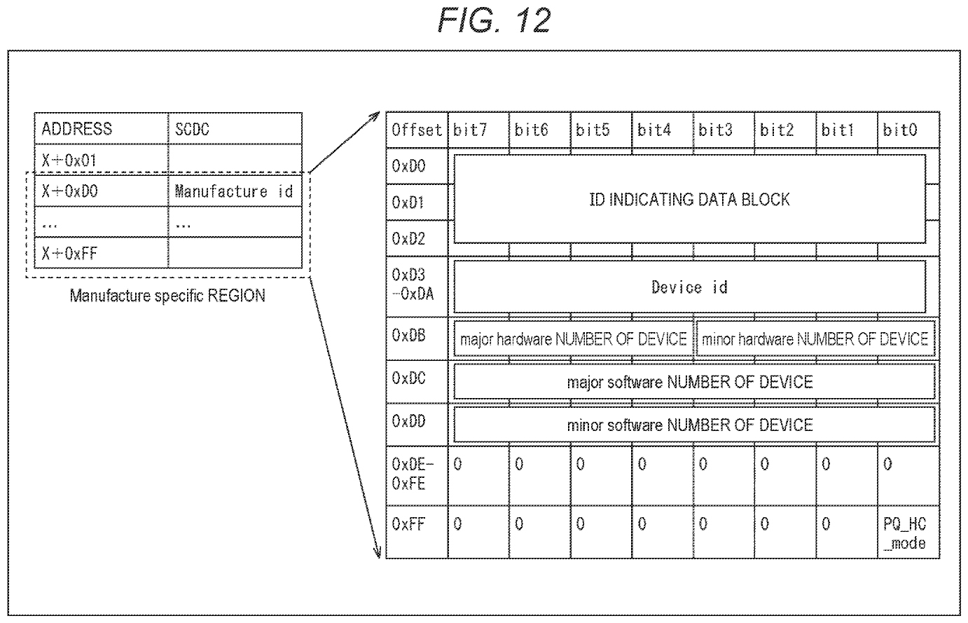

FIG. 12 is a diagram illustrating an example of pieces of information stored is a manufacture specific region in the SCDC.

As illustrated on the left side of FIG. 12, address regions from X+0×D0 to X+0×FF are assigned to a manufacture specific region.

In the manufacture specific region, various types of information related to the specification of the display device 2 such as a device id that is identification information of the device and hardware/software numbers of the device are stored. Using an address region of 0×FF in the manufacture specific region, a PQ_HC_mode flag that is a 1-bit flag is set.

The value of the PQ_HC_mode flag being 1b indicates that the display mode is the PQ hard clipping mode. Furthermore, the value of the PQ_HC_mode flag being 0b indicates that the display mode is a mode other than the PQ hard clipping mode.

After instructing the display device 2 to transition the display mode to the PQ hard clipping mode, the game machine 1 repeatedly checks the value of the PQ_HC_mode flag of the SCDC.

In a case where the value of the PQ_HC_mode flag is set to 1b, the game machine 1 acquires the EDID again in step S16 of FIG. 9. The PQ_HC_mode flag of the SCDC is used to notify the game machine 1 of acquisition timing of the EDID including the HDR static metadata data block in which the HDR capability information for the PQ hard clipping mode is written.

The EDID acquired by the game machine 1 in step S16 as EDID including the HDR static metadata data block an which the HDR capability information for the PQ hard clipping mode obtained by the rewriting in the display device 2 is written. On the basis of the HDR capability information for the PQ hard clipping mode, the game machine 1 can determine the maximum luminance, the maximum average luminance, and the minimum luminance that are the HDR capability during operation in the PQ hard clipping mode.

In step S17, the game machine 1, using an InfoFrame, notes the display device 2 of the HDR information that is information related to an HDR video that starts to be transmitted. This processing is the same processing as the processing of step S4 in FIG. 6.

When the processing in step S17 has been completed, the game machine 1 performs tone mapping in accordance with the HDR capability information for the PQ hard clipping mode, and outputs the HDR video after the tone mapping.

Through the above processing, the game machine 1 can acquire the HDR capability of the display during operation in the PQ hard clipping mode, and perform tone mapping in accordance with the HDR capability.

Since the display device 2 operated in the PQ hard clipping mode does not perform tone mapping using a PQ curve on an HDR video on which the tone mapping has been performed by the game machine 1, overwriting the result of the tone mapping in the game machine 1 can be prevented. That is, the game machine 1 can appropriately perform luminance adjustment and cause an HDR video after the luminance adjustment as intended by the game machine 1 has been performed to be displayed.

(2) Data Block for PQ Hard Clipping Mode

A data block in which the HDR capability information for the PQ hard clipping mode is written may be included in EDID in advance. The configuration of the EDID is a configuration obtained by using the new data block. In this case, rewriting of the HDR capability information is not performed.

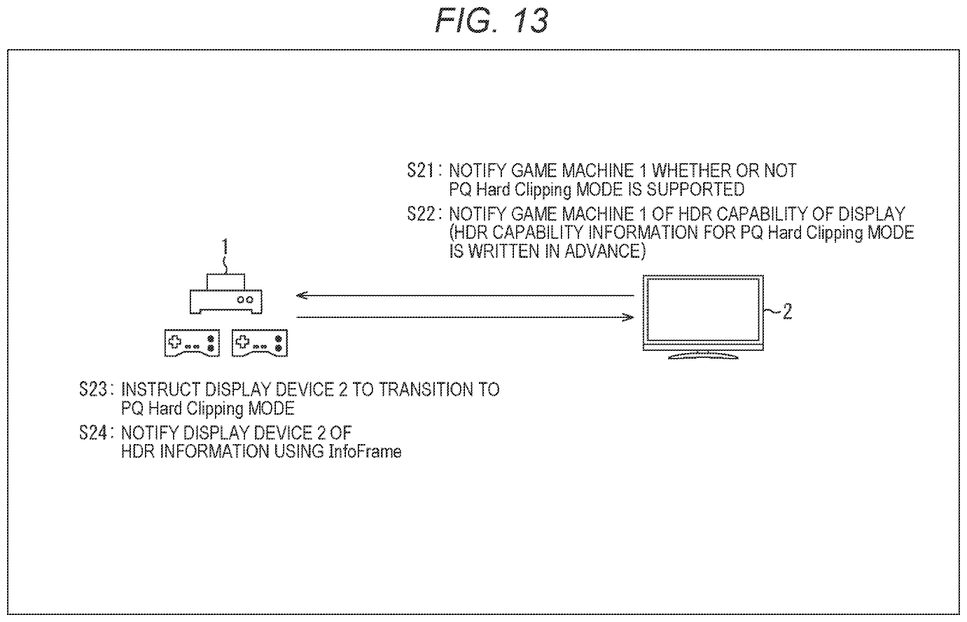

FIG. 13 is a diagram illustrating a flow of operations performed between the game machine 1 and the display device 2.

The operations in steps S21 to S24 illustrated in FIG. 13 are the same operations as the operations in steps S1 to S4 described with reference to FIG. 6, respectively, except that the notification of the HDR capability is performed in step S22 using the EDID including a data block in which the HDR capability information for the PQ hard clipping mode is written and which is provided in advance. Duplicate description is appropriately omitted.

In step S22, the display device 2 notifies the game machine 1 of the HDR capability during operation in the PQ hard clipping mode using the EDID including a data block in which the HDR capability information for the PQ hard clipping mode is written and which is provided in advance.

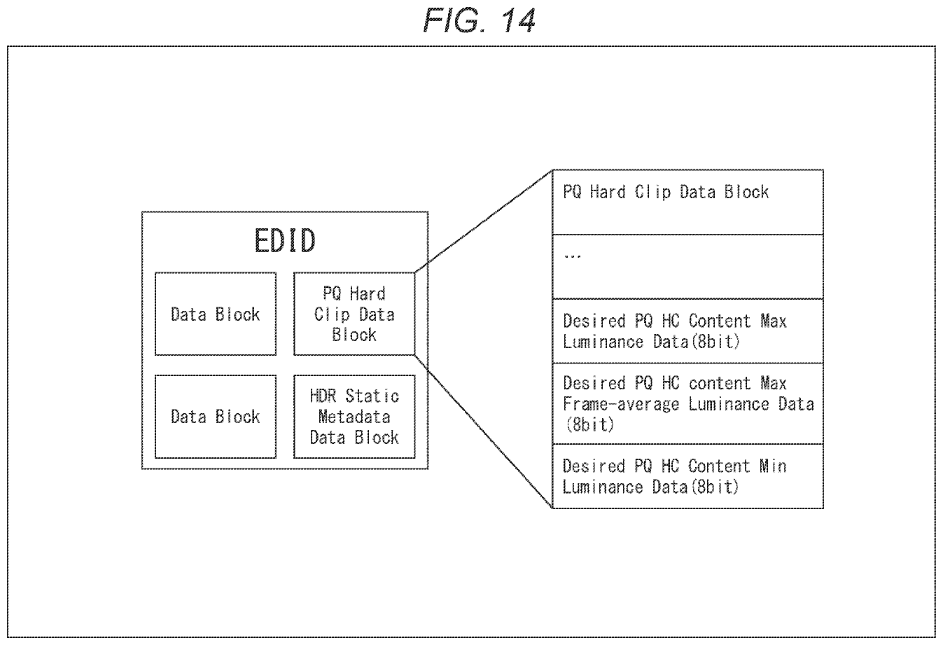

FIG. 14 is a diagram schematically illustrating pieces of data included in the EDID.

As illustrated in FIG. 14, a PQ hard clip data block is included as a data block included in the EDID, separately from the HDR static metadata data block. The PQ hard clip data block is a data block in which the HDR capability information for the PQ hard clipping mode is written.

The PQ hard clip data block includes desired PQ HC content max luminance data, desired PQ HC content max frame-average luminance data, and desired PQ HC content min luminance data, each of which is 8-bit data.

The desired PQ HC content max luminance data represents the maximum luminance of a part of the entire screen that can be received as input during operation in the PQ hard clipping mode.

The desired PQ HC content max luminance data represents the maximum of the average luminance of the entire screen that can be received as input during operation in the PQ hard clipping mode.

The desired PQ HC content max luminance data represents the minimum luminance of a part of the entire screen that can be received as input during operation in the PQ hard clipping mode.

Note that, in the HDR static metadata data block in FIG. 14, desired content max luminance data, desired content max frame-average luminance data, and desired content min luminance data are written. As HDR capability information included in the HDR static metadata data block, the values on the assumption that display tone mapping is to be performed are set.

As described above, the notification of HDR capability can be performed using the EDID including the PQ hard clip data block that is a data block in which HDR capability information for the PQ hard clipping mode and that is provided in advance is written.

The game machine 1 can acquire the HDR capability of the display during operation in the PQ hard clipping mode, and perform tone mapping in accordance with the HDR capability.

Furthermore, since the display device 2 operated in the PQ hard clipping mode does not perform tone mapping using a PQ curve on an HDR video on which the tone mapping has been performed by the game machine 1, overwriting the result of the tone mapping in the game machine 1 can be prevented.

In a case where the display mode is transitioned to the PQ hard clipping mode in accordance with the instruction from the game machine 1, the display device 2 may notify the game machine 1 of the transition to the PQ hard clipping mode using the SCDC.

(3) Extension of Existing HDR Static Metadata Data Block

The HDR capability information for the PQ hard clipping mode may be additionally written in the HDR static metadata data block that is an existing data block included in the EDID. The configuration of the EDID is a configuration that includes an HDR static metadata data block obtained by extending existing description contents.

A length field indicating a data length is provided at the head of each data block included in the EDID. By changing the value of the length field, the HDR static metadata data block can be extended, and the HDR capability information for the PQ hard clipping mode can be additionally written.

The operations performed between the game machine 1 and the display device 2 are basically the same operations as the operations described with reference to FIG. 13.

In step S22, the display device 2 notifies the game machine 1 of the HDR capability during operation in the PQ hard clipping mode using the EDID including the HDR. static metadata data block in which the HDR capability information for the PQ hard clipping mode is additionally written.

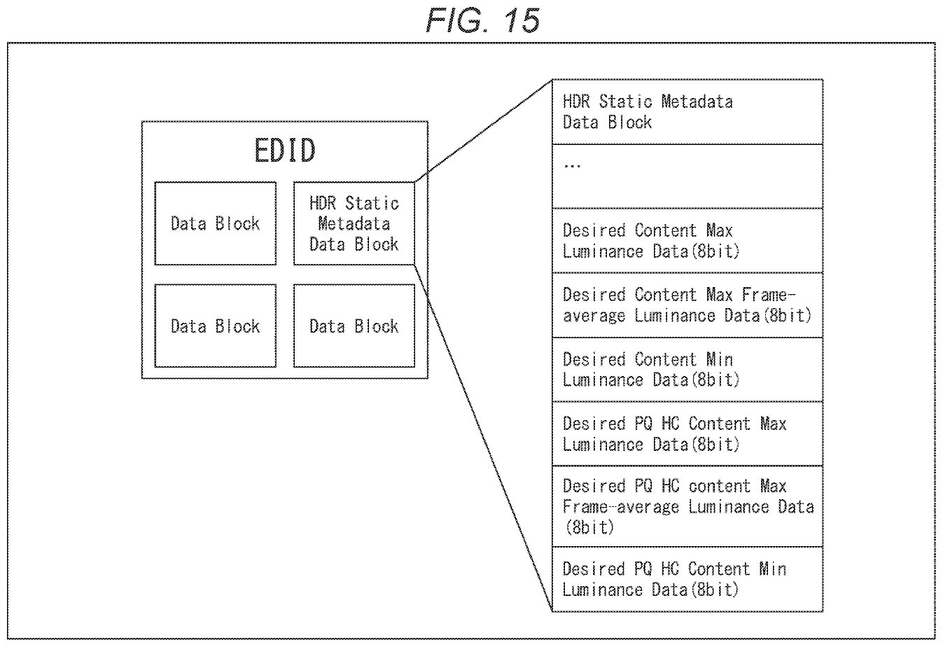

FIG. 15 is a diagram schematically illustrating pieces of data included in the EDID.

As illustrated in FIG. 15, data blocks included in the EDID include the HDR static metadata data block.

The HDR static metadata data block includes desired content max luminance data, desired content max frame-average luminance data, and desired content min luminance data These pieces of HDR capability information are information in which values on the assumption that display tone mapping is to be performed are set.

Furthermore, the HDR static metadata data block includes desired PQ HC content max luminance data, desired PQ HC content max frame-average luminance data, and desired PQ HC content min luminance data. These pieces of HDR capability information are HDR capability information for the PQ hard clipping mode.

As described above, the notification of HDR capability can be performed using the EDID including the HDR static metadata data block in which HDR capability information for the PQ hard clipping mode is additionally written.

The game machine 1 can acquire the HDR capability of the display during operation in the PQ hard clipping mode, and perform tone mapping in accordance with the HDR capability.

<Configuration of Each Device>

Configuration of Game Machine

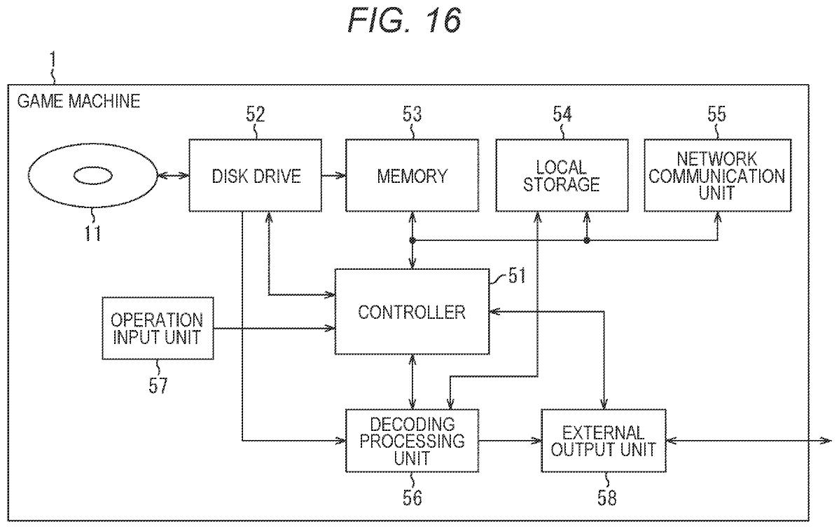

FIG. 16 is a block diagram illustrating a configuration example of the game machine 1.

The game machine 1 includes a controller 51, a disk drive 52, a memory 53, a local storage 54, a network communication unit 55, a decoding processing unit 56, an operation input unit 57, and an external output unit 58.

The controller 51 includes a central processing unit (CPU) , a read only memory (ROM), a random access memory (RAM), and the like. The controller 51 executes a predetermined program and controls operations of the entire game machine 1.

The disk drive 52 reads data recorded on the optical disk 11, and outputs the data to the controller 51, the memory 53, or the decoding processing unit 56. For example, the disk drive 52 outputs game software read from the optical disk 11 to the controller 51, and outputs an AV stream to the decoding processing unit 56.

The memory 53 stores data necessary for the controller 51 to perform various types of processing such as a program executed by the controller 51.

The local storage 54 includes a recording medium such as a hard disk drive (HDD) or a solid state drive (SSD). In the local storage 54, game software and the like downloaded from a server are recorded.

The network communication unit 55 is an interface such as a wireless LAN or a wired LAN. For example, the network communication unit 55 communicates with the server via the network 12 such as the Internet, and supplies data downloaded from the server to the local storage 54.

The decoding processing unit 56 decodes video streams multiplexed into the AV stream supplied from the disk drive 52, and outputs video data obtained by the decoding to the external output unit 58. An HDR video forming the video of a game may be generated by decoding the video streams. Furthermore, the decoding processing unit 56 decodes audio streams multiplexed into the AV stream, and outputs audio data obtained by the decoding to the external output unit 58.

The operation input unit 57 receives a signal transmitted from a remote controller by wireless communication. The operation input unit 57 detects an operation by a user and supplies a signal indicating the content of the operation by the user to the controller 51.

The external output unit 58 is an interface for external output such as HDMI. The eternal output unit 58 communicates with the display device 2 via an HDMI cable to transmit and receive, for example, various types of information as described with reference to FIG. 8 and FIG. 9, to and from the display device 2.

For example, the external output unit 58 outputs the HDR video data supplied from the controller 51 or the HDR video data supplied from the decoding processing unit 56 to the display device 2.

As described above, the external output unit 58 functions as a communication unit that transmits and receives information related to an HDR video to and from the display device 2 and outputs the HDR video to the display device 2.

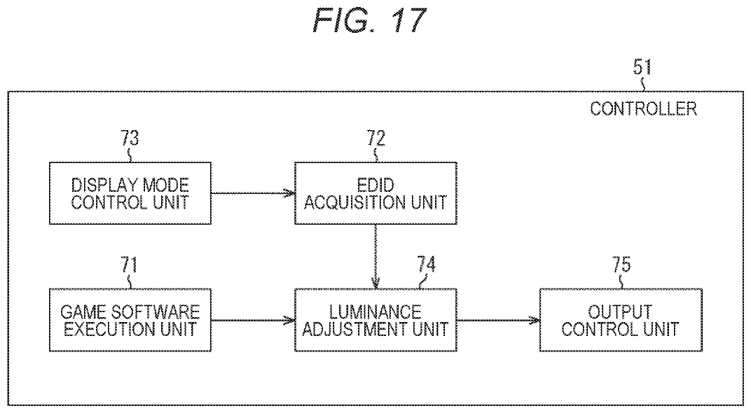

FIG. 17 is a block diagram illustrating a functional configuration example of the controller 51.

In the controller 51, a game software execution unit 71, an EDID acquisition unit 72, a display mode control unit 73, a luminance adjustment unit 74, and an output control unit 75 are implemented. At least a part of the functional units illustrated in FIG. 17 is implemented by the CPU of the controller 51 executing a predetermined program.

The game software execution unit 71 executes game software read from the optical disk 11 or game software recorded in the local storage 54.

The game software execution unit 71 generates pictures of an HDR video forming the video of a game by executing the game software. The game software execution unit 71 outputs data of the pictures of the HDR video to the luminance adjustment unit 74.

The EDID acquisition unit 72 communicates with the display device 2 by controlling the external output unit 58, and acquires the EDID managed by the display device 2.

For example, in a case where the EDID is chanced as in (1) described above, processing of step S16 (FIG. 9) of repeatedly checking the value of the PQ_HC_mode flag of the SCDC and acquiring the EDID in response to change of the value of the PQ_HC_mode flag to 1b is performed by the EDID acquisition unit 72.

In a case where a data block for the PQ hard clipping mode is provided in advance as in (2) described above, processing of acquiring the EDID including the HDR capability information during operation in the PQ hard clipping mode that has been provided in notification from the display device 2 in step S22 (FIG. 13) is performed by the EDID acquisition unit 72.

In a case where an extended HDR static metadata data block is provided as in (3) described above, processing of acquiring the EDID including the HDR capability information during operation in the PQ hard clipping mode that has been provided in notification from the display device 2 in step S22 (FIG. 13) is performed by the EDID acquisition unit 72.

The EDID acquisition unit 72 outputs the HDR capability information written in the data block included in the EDID acquired from the display device 2 to the luminance adjustment unit 74.

The display mode control unit 73 communicates with the display device 2 by controlling the external output unit 58 to control display modes of the display device 2.

For example, in a case, where the display device 2 supports the PQ hard clipping mode, the processing of instructing the display device 2 to transition to the PQ hard clipping mode (step S13 in FIG. 8 and step S23 in FIG. 13) is performed by the display mode control unit 73.

In a case where the display mode of the display device 2 is transitioned to the PQ hard clipping mode, the display mode control unit 73 outputs information indicating the transition to the EDID acquisition unit 72.

The luminance adjustment unit 74 performs luminance adjustment of an HDR video on the basis of HDR capability information supplied from the EDID acquisition unit 72.

In a case where the display mode of the display device 2 is a display mode different from the PQ hard clipping mode, the luminance adjustment unit 74 performs display tone mapping on the basis of the HDR capability information, and outputs data of an HDR video after the display tone mapping to the output control unit 75. In this case, the EDID acquisition unit 72 supplies HDR capability information on the assumption that display tone mapping is to be performed.

Furthermore, in a case where the display mode of the display device 2 is the PQ hard clipping mode, the luminance adjustment unit 74 performs display tone mapping on the basis of the HDR capability information, and outputs data of an HDR video after the display tone mapping to the output control unit 75. In this case, the EDID acquisition unit 72 supplies HDR capability information for the PQ hard clipping mode that is on the assumption that display tone mapping is not to be performed.

The output control unit 75 outputs an HDR video to the display device 2 by controlling the external output unit 58.

Configuration of Display Device

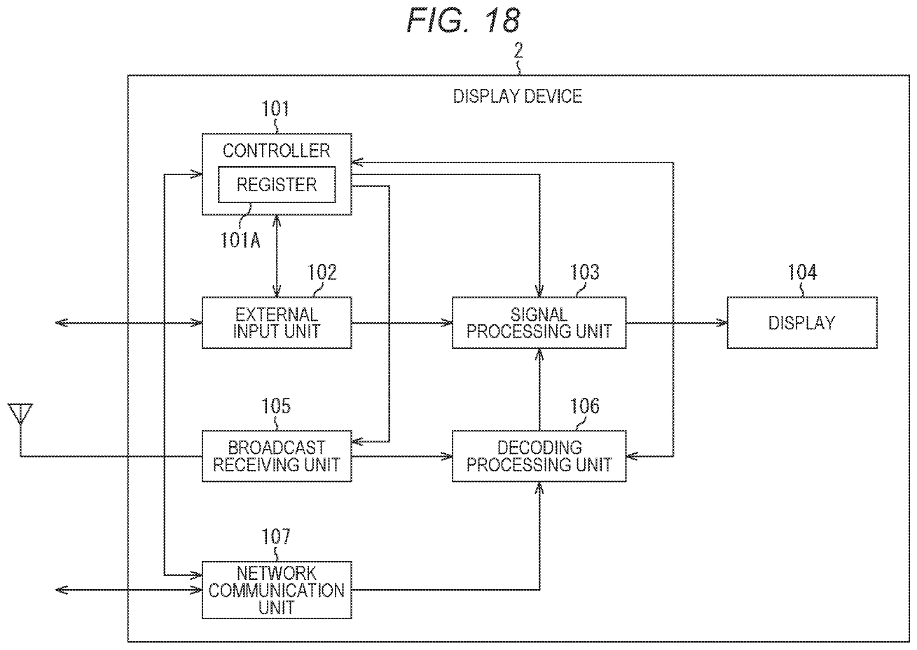

FIG. 18 is a block diagram illustrating a configuration example of the display device 2.

The display device 2 includes a controller 101, an external input unit 102, a signal processing unit 103, a display 104, a broadcast receiving unit 105, a decoding processing unit 106, and a network communication unit 107.

The controller 101 includes a CPU, a ROM, a RAM, and the like. The controller 101 executes a predetermined program and controls operations of the entire display device 2.

The controller 101 includes a register 101A. An SCDC is formed by the register 101A.

The external input unit 102 is an interface for external input such as HDMI. The external input unit 102 communicates with the game machine 1 via an HDMI cable and transmits information such as EDID to the game machine 1. Furthermore, the external input unit 102 receives data of pictures of an HDR video transmitted from the game machine 1 and outputs the data to the signal processing unit 103.

As described above, the external input unit 102 functions as a communication unit that transmits and receives information related to an HDR video to and from the game machine 1 and receives the HDR video from the game machine 1.

The signal processing unit 103 performs processing of an HDR video supplied from the external input unit 102 and causes the video of a game to be displayed on the display 104. The signal processing unit 103 performs, under the control of the controller 101, luminance adjustment of an HDR video.

The signal processing unit 103 also performs processing of causing the video of a program to be displayed on the display 104 on the basis of data supplied from the decoding processing unit 106.

The display 104 is a display device such as an organic EL display or an LCD. The display 104 displays the video of a game or the video of a program on the basis of a video signal supplied from the signal processing unit 103.

The broadcast receiving unit 105 extracts a broadcast signal of a predetermined channel from a signal supplied from an antenna, and outputs the broadcast signal to the decoding processing unit 106. The extraction of the broadcast signal by the broadcast receiving unit 105 is performed under the control of the controller 101.

The decoding processing unit 106 performs processing such as decoding on a broadcast signal supplied from the broadcast receiving unit 105, and outputs video data of the program to the signal processing unit 103.

The network communication unit 107 is an interface such as a wireless LAN or a wired LAN. The network communication unit 107 communicates with a server via the Internet.

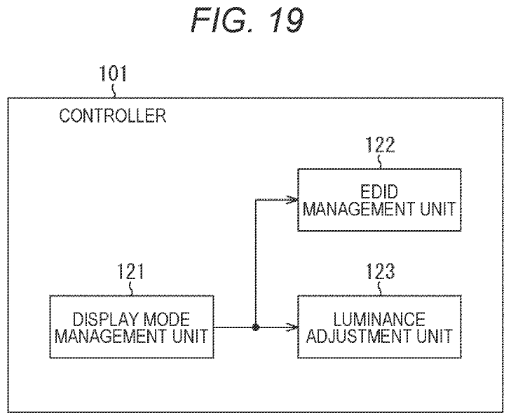

FIG. 19 is a block diagram illustrating a functional configuration example of the controller 101.

In the controller 101, a display mode management unit 121, an EDID management unit 122, and a luminance adjustment unit 123 are included. At least a part of the functional units illustrated in FIG. 19 is formed by executing a predetermined program by the CPU of the controller 101.

The display mode management unit 121 manages display modes of the display device 2.

For example, the display mode management unit 121 communicates with the game machine 1 by controlling the external input unit 102, and sets the PQ hard clipping mode as a display mode of the display device 2 in a case where transitioning to the PQ hard clipping mode is instructed. The processing of rewriting the value of the PQ_HC_mode flag in response to the setting of the PQ hard clipping mode (step S15 in FIG. 9) is performed by the display mode management unit 121.

In a case where the display mode of the display device 2 is transitioned to the PQ hard clipping mode, the display mode management unit 121 outputs information indicating the transition to the EDID management unit 122 and the luminance adjustment unit 123.

The EDID management unit 122 manages EDID that is information indicating the capability of the display device 2. The EDID management unit 122 communicates with the game machine 1 by controlling the external input unit 102 to transmit the EDID to the game machine 1.

For example, in a case where the EDID is changed as in (1) described above, processing of seep S14 (FIG. 9) of rewriting the values of the HDR capability information on the assumption that display tone mapping is to be performed into the values of the HDR capability information for the PQ hard clipping mode is performed by the EDID management unit 122.

In a case where a data block for the PQ hard clipping mode is provided in advance as in (2) described above, or in a case where an extended HDR static metadata data block is provided as in (3) described above, the EDID management unit 122 manages EDID including such information.

The luminance adjustment unit 123 controls the signal processing unit 103 to control luminance adjustment in the display device 2.

That is, in a case where the display mode of the display device 2 is a display mode other than the PQ hard clipping mode, the luminance adjustment unit 123 causes the signal processing unit 103 to perform display tone mapping based on a PQ curve.

Furthermore, in a case where the display mode of the display device 2 is the PQ hard clipping mode, the luminance adjustment unit 123 causes the signal processing unit 103 to perform luminance adjustment by PQ hard clipping.

Aspects of Information Processing System

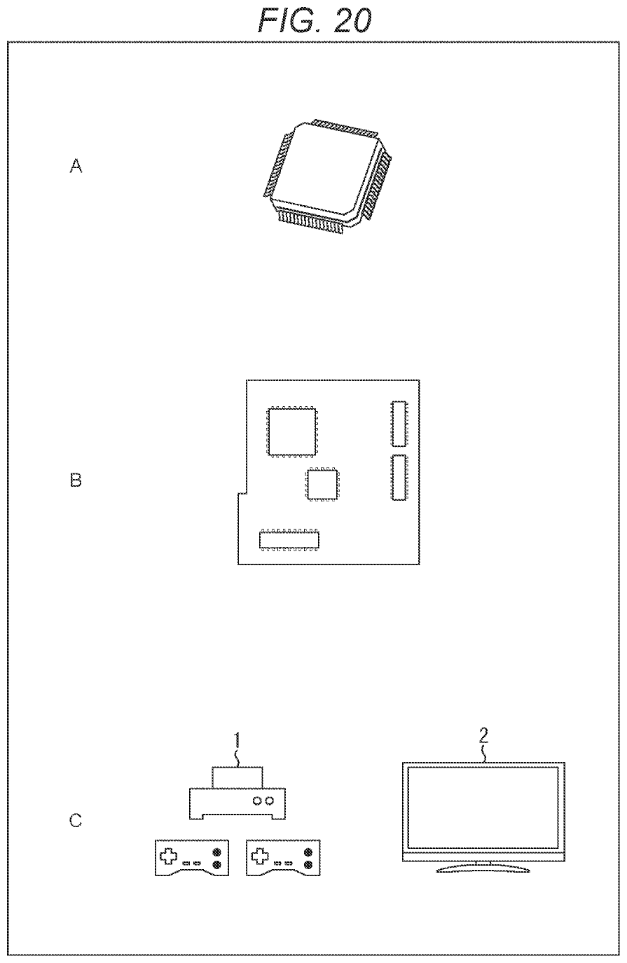

FIG. 20 is a diagram illustrating examples of aspects of an information processing system.

The information processing system including at least the controller 51 and the external output unit 58 (FIG. 16) that are included in the game machine 1 is formed by using an IC chip illustrated in A of FIG. 20 or using a substrate illustrated in B of FIG. 20 on which electronic components such as IC chips are disposed.

The information processing system including the controller 51 and the external output unit 58 may be formed as the game machine 1 illustrated in C of FIG. 20 that is a device including a housing in which members such as an IC chip and a substrate are housed.

That is, the information processing system including the controller 51 and the external output unit 58 is formed in any aspect of an IC chip, a substrate, or a device.

Similarly, the information processing system including at least the controller 101 and the external input unit 102 (FIG. 18) that are included in the display device 2 is formed by using an IC chip illustrated in A of FIG. 20 or using a substrate illustrated in B of FIG. 20 on which electronic components such as IC chips are disposed.

The information processing system including the controller 101 and the external input unit 102 may be formed as the display device 2 illustrated in C of FIG. 20 that is a device including a housing in which members such as an IC chip and a substrate are housed.

That is, the information processing system including the controller 101 and the external input unit 102 is formed in any aspect of an IC chip, a substrate, or a device.

As described above, each of the information processing system including the controller 51 and the external output unit 56 and the information processing system including the controller 101 and the external input unit 102 can be formed by using any aspect of an IC chip, a substrate, or a device.

The information processing system including the controller 51 and the external output unit 58 and the information processing system including the controller 101 and the external input unit 102 can, for example, be formed by using a plurality of devices connected via a network, that is, they can be formed as devices of various aspects.

<Modifications>

Although various types of processing including luminance adjustment by PQ hard clipping have been described as being performed by the game machine 1, at least some of the functions of the game machine 1 can be formed by using game software executed by the game machine 1.

In this case, the game software executed in the game machine 1 appropriately utilizes a function of another program, for example, by using an application programming interface (API) to perform the same processing as the processing of the game machine 1 that is described above.

Although an output source device of HDR videos has been described as the game machine 1, various devices that reproduce movie content such as players, PCs, smartphones, tablet terminals, and wearable devices can also be used as the output source device of HDR videos. Each of the devices serving as an output source device of HDR videos performs the same processing as the processing of the game machine 1 that is described above.

Regarding Program

The above-described series of processing can be performed by hardware or software. In a case where the series of processing is performed by software, a program included in the software is installed, from a program recording medium, in a computer incorporated in dedicated hardware, a general-purpose personal computer, or the like.

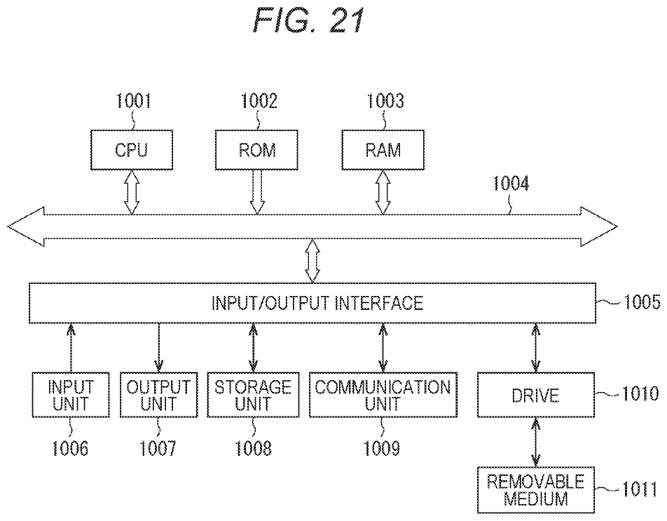

FIG. 21 is a block diagram illustrating a configuration example of the hardware of the computer that performs the above-described series of processing by a program.

A central processing unit (CPU) 1001, a read only memory (ROM) 1002, and a random access memory (RAM) 1003 are mutually connected by a bus 1004.

To the bus 1004, an input/output interface 1005 is further connected. To the input/output interface 1005, an input unit 1006 including a keyboard, a mouse, or the like, and an output unit 1007 including a display, a speaker, or the like are connected. To the input/output interface 1005, a storage unit 1008 including a hard disk, a nonvolatile memory, and the like, a communication unit 1009 including a network interface and the like, and a drive 1010 that drives a removable medium 1011 are further connected.

In the computer formed as described above, for example, the CPU 1001 loads a program stored in the storage unit 1008 into the RAN 1003 via the input/output interface 1005 and the bus 1004 and executes the program, whereby the above-described series of processing is performed.

The program executed by the CPU 1001 is provided, for example, being recorded in the removable medium 1011 or via a wired or wireless transmission medium such as a local area network, the Internet, and digital broadcasting, and is installed in the storage unit 1008.

Note that the program executed by the computer may be a program that causes processing to be performed in time series in the order described in the present specification or in parallel, or may be a program that causes the processing to be performed at necessary timing such as when it's called.

Note that the effects described in the present specification are merely examples and effects are not limited thereto, and other effects may be provided.

The embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Furthermore, each of the above-described steps can be performed by one device or can be shared and performed by a plurality of devices.

Moreover, in a case where a plurality of types of processing is included in one step, the plurality of types of processing included in the one step can be performed by one device or can be shared and performed by a plurality of devices.

Example Combination of Configurations

The present technology can also have following configurations.

(1)

An information processing system including

a communication unit that transmits, to an output source device of an HDR video, capability information including first information indicating display capability of an HDR video when a first display mode is set in which luminance adjustment of an HDR video is performed by PQ hard clipping.

(2)

The information processing system according to the (1) further including

a capability information management unit that rewrites second information indicating display capability of an HDR video when a second display mode is set in which luminance adjustment of an HDR video is to be performed on a display side by a method different from PQ hard clipping,

in which the communication unit transmits, as the capability information, EDID including a data block in which the first information into which the second information is rewritten is written.

(3)

The information processing system according to the (2) further including

a display mode management unit that causes a display mode to transition from the second display mode to the first display mode according to control by the output source device,

in which the capability information management unit rewrites the second information into the first information in response to transition from the second display mode to the first display mode.

(4)

The information processing system according to the (3),

in which the display mode management unit sets a flag indicating that the first display mode is set.

(5)

The information processing system according to the (1),

in which the communication unit transmits, as the capability information, EDID in which the first information and second information indicating display capability of an HDR video when a second display mode is set in which luminance adjustment of an HDR video is performed on a display side by a method different from PQ hard clipping are written in respective different data blocks.

(6)

The information processing system according to the (1),

in which the communication unit transmits, as the capability information, EDID in which the first information and second information indicating display capability of an HDR video when a second display mode is set in which luminance adjustment of an HDR video is performed on a display side by a method different from PQ hard clipping are written in a same data block.

(7)

The information processing system according to the (3) further including

a luminance adjustment unit that performs luminance adjustment of an HDR video input from the output source device by PQ hard clipping or by a method different from PQ hard clipping according to a display mode set by the display mode management unit.

(8)

The information processing system according to the (7) further including

a display that displays an HDR video after the luminance adjustment is performed.

(9)

The information processing system according to any one of the (1) to (8),

in which luminance adjustment by PQ hard clipping is luminance adjustment in which luminance adjustment using a PQ curve is performed in the output source device, and luminance exceeding maximum luminance of a display is compressed to the maximum luminance in an our destination device.

(10)

An information processing method

performed by an information processing system, including

transmitting, to an output source device of an HDR video, capability information including information display capability of an HDR video when a display mode is set in which luminance adjustment of an HDR video is performed by PQ hard clipping.

(11)

An information processing system including

a communication unit that acquires, from a display device including a display that is an output destination of an HDR video, capability information including first information indicating display capability of an HDR video when a first display mode is set in which luminance adjustment of an HDR video is performed by PQ hard clipping.

(12)

The information processing system according to the (11),

in which the communication unit acquires, as the capability information, EDID including a data block in which the first information into which second information indicating display capability of an HDR video when a second display mode is set in which luminance adjustment of an HDR video is to be performed on a display side by a method different from PQ hard clipping is rewritten is written.

(13)

The information procession system according to the (12) further including

a display mode control unit that causes a display mode of the display device to transition from the second display mode to the first display mode.

(14)

The information processing system according to the (13),

in which the communication unit acquires the capability information in response to setting, in the display device, of a flag indicating that the first display mode is set.

(15)

The information processing system according to the (11),

in which the communication unit acquires, as the capability information, EDID in which the first information and second information indicating display capability of an HDR Video when a second display mode is set in which luminance adjustment of an HDR video is performed on a display side by a method different from PQ hard clipping are written in respective different data blocks.

(16)

The information processing system according to the (11),

in which the communication unit acquires, as the capability information, EDID in which the first information and second information indicating display capability of an HDR video when a second display mode is set in which luminance adjustment of an HDR video is performed on a display side by a method different from PQ hard clipping are written in a same data block.

(17)

The information processing system according to any one of the (12) to (16) further including

a luminance adjustment unit that performs luminance adjustment of an HDR video to be displayed on the display device on a basis of the first information included in the capability information or on a basis of the second information according to a display mode set in the display device.

(18)

The information processing system according to any one of the (11) to (17) further including

an operation input unit that receives an operation by a user.

(19)

An information processing method

performed by an information processing system, including

acquiring, from a display device including a display that is an output destination of an HDR video, capability information including information indicating display capability of an HDR video when a display mode is set in which luminance adjustment of an HDR video is performed by PQ hard clipping.

(20)

A program that causes

a computer to perform processing including

acquiring, from a display device including a display that is an output destination of an HDR video, capability information including information indicating display capability of an HDR video when a display mode is set in which luminance adjustment of an HDR video is performed by PQ hard clipping and

controlling luminance conversion of an HDR video to be output to the display device on a basis of the capability information.

### REFERENCE SIGNS LIST

1 Game machine
2 Display device
51 Controller
58 External output unit
71 Game software execution unit
72 EDID acquisition unit
73 Display mode control unit
74 Luminance adjustment unit
75 Output control unit
101 Controller
102 External input unit
104 Display
121 Display mode management unit
122 EDID management unit
123 Luminance adjustment unit

1. An information processing system comprising
a communication unit that transmits, to an output source device of an HDR video, capability information including first information indicating display capability of an HDR video when a first display mode is set in which luminance adjustment of an HDR video is performed by PQ hard clipping.

2. The information processing system according to claim 1 further comprising
a capability information management unit that rewrites second information indicating display capability of an HDR video when a second display mode is set in which luminance adjustment of an HDR video is to be performed on a display side by a method different from PQ hard clipping,
wherein the communication unit transmits, as the capability information, EDID including a data block in which the first information into which the second information is rewritten is written.

3. The information processing system according to claim 2 further comprising
a display mode management unit that causes a display mode to transition from the second display mode to the first display mode according to control by the output source device,
wherein the capability information management unit rewrites the second information into the first information in response to transition from the second display mode to the first display mode.

4. The information processing system according to claim 3,
wherein the display mode management unit sets a flag indicating that the first display mode is set.

5. The information processing system according to claim 1,
wherein the communication unit transmits, as the capability information, EDID in which the first information and second information indicating display capability of an HDR video when a second display mode is set in which luminance adjustment of an HDR video is performed on a display side by a method different from PQ hard clipping are written in respective different data blocks.

6. The information processing system according to claim 1,
wherein the communication unit transmits, as the capability information, EDID in which the first information and second information indicating display capability of an HDR video when a second display mode is set in which luminance adjustment of an HDR video is performed on a display side by a method different from PQ hard clipping are written in a same data block.

7. The information processing system according to claim 3 further comprising
a luminance adjustment unit that performs luminance adjustment of an HDR video input from the output source device by PQ hard clipping or by a method different from PQ hard clipping according to a display mode set by the display mode management unit.

8. The information processing system according to claim 7 further comprising
a display that displays an HDR video after the luminance adjustment is performed.

9. The information processing system according to claim 1,
wherein luminance adjustment by PQ hard clipping is luminance adjustment in which luminance adjustment using a PQ curve is performed in the output source device, and luminance exceeding maximum luminance of a display is compressed to the maximum luminance in an output destination device.

10. An information processing method
performed by an information processing system, comprising
transmitting, to an output source device of an HDR video, capability information including information indicating display capability of an HDR video when a display mode is set in which luminance adjustment of an HDR video is performed by PQ hard clipping.

11. An information processing system comprising
a communication unit that acquires, from a display device including a display that is an output destination of an HDR video, capability information including first information indicating display capability of an HDR video when a first display mode is set in which luminance adjustment of an HDR video is performed by PQ hard clipping.

12. The information processing system according to claim 11,
wherein the communication unit acquires, as the capability information, EDID including a data block in which the first information into which second information indicating display capability of an HDR video when a second display mode is set in which luminance adjustment of an HDR video is to he performed on a display side by a method different from PQ hard clipping is rewritten is written.

13. The information processing system according to claim 12 further comprising
a display mode control unit that causes a display mode of the display device to transition from the second display mode to the first display mode.

14. The information processing system according to claim 13,
wherein the communication unit acquires the capability information in response to setting, in the display device, of a flag indicating that the first display mode is set.

15. The information procession system according to claim 11,
wherein the communication unit acquires, as the capability information, EDID in which the first information and second information indicating display capability of an HDR video when a second display mode is set in which luminance adjustment of an HDR video is performed on a display side by a method different from PQ hard clipping are written in respective different data blocks.

16. The information processing system according to claim 11,
wherein the communication unit acquires, as the capability information, EDID in which the first information and second information indicating display capability of an HDR video when a second display mode is set in which luminance adjustment of an HDR video is performed on a display side by a method different from PQ hard clipping are written in a same data block.

17. The information processing system according to claim 12 further comprising
a luminance adjustment unit that performs luminance adjustment of an HDR video to be displayed on the display device on a basis of the first information included in the capability information or on a basis of the second information according to a display mode set in the display device.

18. The information processing system according to claim 11 further comprising
an operation input unit that receives an operation by a user.

19. An information processing method
performed by an information processing system, comprising
acquiring, from a display device including a display that is an output destination of an HDR video, capability information including information indicating display capability of an HDR video when a display mode is set in which luminance adjustment of an HDR video is performed by PQ hard clipping.

20. A program that causes
a computer to perform processing including
acquiring, from a display device including a display that is an output destination of an HDR video, capability information including information indicating display capability of an HDR video when a display mode is set in which luminance adjustment of an HDR video is performed by PQ hard clipping and
controlling luminance conversion of an HDR video to be output to the display device on a basis of the capability information.
